(19) United States
(12) Patent Application Publication
(10) Pub. No.: US 2014/0174255 A1
(43) Pub. Date: Jun. 26, 2014

(54) HARD-FACED ARTICLE

(71) Applicant: Brent A. Augustine, East Moline, IL (US)

(72) Inventor: Brent A. Augustine, East Moline, IL (US)

(73) Assignee: DEERE & COMPANY, Moline, IL (US)

(21) Appl. No.: 13/726,815

(22) Filed: Dec. 26, 2012

(51) Int. Cl. B32B 33/00; B05D 5/00

(52) U.S. Cl. CPC B32B 33/00; B05D 5/00
USPC 75/238; 427/180; 75/244; 75/243

(57) ABSTRACT

A hard-faced article includes a wear-resistance element that has a precipitated hard phase and a non-precipitated hard phase that is different from the precipitated hard phase in composition. The precipitated hard phase and the non-precipitated hard phase are dispersed through a boron-containing metallic matrix. The precipitated hard phase includes a boride material. The wear-resistance element can include, by weight, less than 50% of the non-precipitated hard phase. The wear-resistance element can also include boron, carbon, chromium and silicon such that, by weight exclusive of the non-precipitated hard phase, a product of the amounts of boron, carbon, chromium and silicon is greater than 28 and less than 350 and the amount of chromium by weight is less than 15%. A method includes forming the wear-resistance element with the precipitated hard phase and the non-precipitated hard phase dispersed through the boron-containing metallic matrix.

### BACKGROUND

This disclosure relates an article that has a hard-facing to protect from abrasion or the like.

Component wear in agricultural, heavy equipment and other industries increases expenses due to component replacement or repair. Small components can be made entirely of wear-resistant material if wear is a concern. However, wear-resistant material is relatively expensive and it is not feasible to make large components entirely out of wear-resistant material. To reduce the amount of wear-resistant material, a component can be coated with the wear-resistant material. A wear-resistant coating can be applied using a spray-welding technique, such as flame or plasma spraying, or powder metal technique.

### SUMMARY

A hard-faced article includes a wear-resistance element that has a precipitated hard phase and a non-precipitated hard phase that is different from the precipitated hard phase in composition. The precipitated hard phase and the non-precipitated hard phase are dispersed through a boron-containing metallic matrix. The precipitated hard phase includes a boride material.

In another aspect, a hard-faced article includes a wear-resistance element that has a precipitated hard phase and, by weight, less than 50% of a non-precipitated hard phase that is different from the precipitated hard phase in composition. The precipitated hard phase and the non-precipitated hard phase are dispersed through a boron-containing metallic matrix. The precipitated hard phase includes a boron-containing material. The wear-resistance element includes boron, carbon, chromium and silicon such that, by weight exclusive of the non-precipitated hard phase, a product of the amounts of boron, carbon, chromium, and silicon is greater than 28 and less than 350 and the amount of chromium by weight is less than 15%.

Also disclosed is a method of processing a hard-faced article.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 illustrates an example hard-faced article.

FIG. 2 illustrates another embodiment of a hard-faced article.

FIG. 3 illustrates an example implementation of a hard-faced article.

FIG. 4 illustrates an example method of processing a hard-faced article.

### DETAILED DESCRIPTION OF THE PREFERRED EMBODIMENT

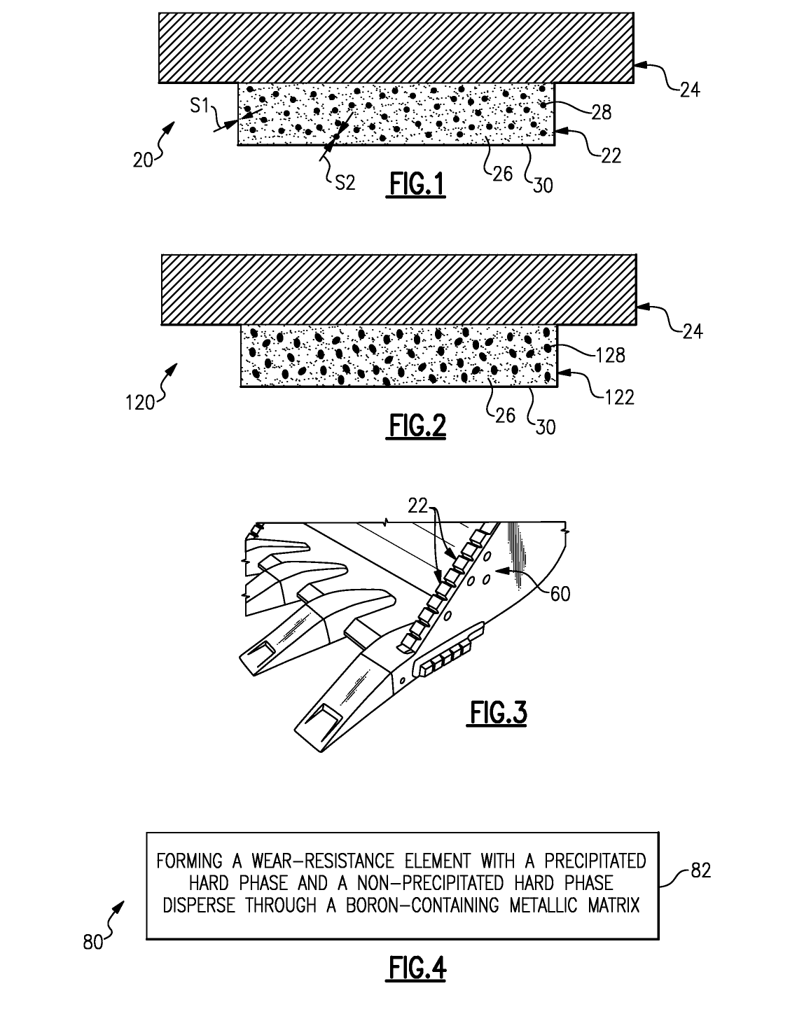

FIG. 1 schematically shows an example hard-faced article 20 (hereafter “article 20”). In this example, the article 20 includes a wear-resistance element 22 that is joined to a substrate 24. For example only, the article 20 may be a tool, agricultural implement, vehicle component or the like. It is to be understood, however, that the article 20 is not limited to such applications and can be used for other applications that would benefit from this disclosure.

The wear-resistance element 22 includes a precipitated hard phase 26 and a non-precipitated hard phase 28 that differs from the precipitated hard phase 26 in composition. The precipitated hard phase 26 and the non-precipitated hard phase 28 are dispersed through a boron-containing metallic matrix 30 (hereafter “matrix 30”), and the precipitated hard phase 26 includes a boride material. The precipitated hard phase 26 is precipitated from elements of the matrix 30. The boride material is a boride that forms as a precipitation product from boron and one or more elements of the matrix 30, such as carbon (boron carbide). The precipitated hard phase 26 can also include precipitated carbides, such as chromium carbide, and/or complex multi-metal carbides.

The non-precipitated hard phase 28 is not derived from the elements or material of the matrix 30 and can therefore include elements that are not found in the matrix 30. The non-precipitated hard phase 28 is an additive to the matrix 30. Besides composition, the precipitated hard phase 26 and the non-precipitated hard phase 28 are physically distinguishable, by size or morphology, for example. The phases 26 and 28 refer to regions that have a distinct boundary from the matrix 30.

In further examples, the matrix 30 of the wear- resistance element 22 is a nickel-, iron- or cobalt-based alloy. The alloy composition can include alloy elements in individual amounts of 0.1-20% by weight of boron, silicon, chromium, iron (for nickel- and cobalt-based alloys), carbon, manganese, nickel (for iron- and cobalt-based alloys), tungsten and combinations thereof.

In a further example, the wear-resistance element 22 includes silicon and manganese in a combined amount up 4% by weight to strengthen and toughen the wear-resistance element 22. In a further example, a combined amount by weight of the boron and the carbon is 0.6-6.5 to control the amount of borides and carbides in the wear-resistance element 22, and a combined amount by weight of nickel and chromium is 5-80% to control the amount of nickel and chromium intermetallic phases in the wear-resistance element 22. In a further example, a combined amount by weight of the boron and the carbon is 4-6.5% and a combined amount by weight of the nickel and the chromium is 18-22%.

In further examples, the composition of the wear-resistance element 22, exclusive of the non-precipitated hard phase 28, is a composition set forth in the Table below.

TABLE
Example Compositions 1-4, by weight percentage.

Example

| Element | 1 | 2 | 3 | 4 |
|---|---|---|---|---|
| Boron | 3 | 3.29 | 3.08 | 2 |
| Carbon | 0.7 | 2.18 | 1.98 | 0.6 |
| Chromium | 14.3 | 14.44 | 14.12 | 12.35 |
| Cobalt | — | — | — | Bal. |
| Iron | 4 | Bal. | Bal. | 1.3 |
| Manganese | — | 0.31 | 0.5 | — |
| Nickel | Bal. | 5.72 | 5.64 | 23.5 |
| Silicon | 4.25 | 3.09 | 2.74 | 1.9 |
| Tungsten | — | — | — | 7.6 |

In one further example, the composition of the wear-resistance element 22 includes, by weight and exclusive of the non-precipitated hard phase 28, 3% or greater of boron.

In a further example, the wear-resistance element 22 includes boron, carbon, chromium, and silicon such that, by weight exclusive of the non-precipitated hard phase 28, a product of the amounts of boron, carbon, chromium and silicon is greater than 28 and less than 350 and the amount chromium by weight is less than 15%.

As indicated, the compositions of the precipitated hard phase 26 and the non-precipitated hard phase 28 differ. The phases 26 and 28 can also differ in average size such that the precipitated hard phase 26 has an average size, represented as S1 in FIG. 1, and the non-precipitated hard phase 28 has an average size, represented as S2 in FIG. 1, that is larger than S1. In this example, the regions of the non-precipitated hard phase 28 are spheroidal in shape.

FIG. 2 shows another example hard-faced article 120. In this disclosure, like reference numerals designate like elements where appropriate and reference numerals with the addition of one-hundred or multiples thereof designate modified elements that are understood to incorporate the same features and benefits of the corresponding elements. In this example, the wear-resistant element 122 includes the precipitated hard phase 26 and a non-precipitated hard phase 28 that are dispersed through the matrix 30. Whereas the regions of the non-precipitated hard phase 28 of the hard-faced article 20 are spheroidal in shape, the regions of the non-precipitated hard phase 128 in the wear-resistance element 122 are non-spherical. For example, the non-precipitated hard phase 128 has an aspect ratio of 1-5. In a further example, the ratio is 1-3.2. In a further example the ratio is greater than 1.5 and in one example is 1.7.

In further examples, the non-precipitated hard phase 28/128 can include carbides, nitrides or other inorganic materials that are harder than the matrix 30. For example, the carbides can include tungsten carbide, silicon carbide or combinations thereof. The nitrides can include boron nitride, such as cubic boron nitride.

In a further example, the wear-resistance element 22/122 can include, by weight, up to 50% of the non-precipitated hard phase 28/128. In one example, the wear-resistance element 22/122 includes, by weight, 10-20% of the non-precipitated hard phase 28/128.

FIG. 3 shows one example implementation of the article 20 joined onto a bucket 60, which may be attached to a vehicle. As can be appreciated, the wear-resistance element 122 can alternatively be used.

FIG. 4 shows an example method 80 of processing the wear-resistance element 22/122. The method 80 includes forming the wear-resistance element 22/122 with the precipitated hard phase 26 and the non-precipitated hard phase 28/128 dispersed through the matrix 30. As described, the precipitated hard phase 26 differs from the non-precipitated hard phase 28/128 in composition, and the precipitated hard phase 26 includes a boride material. The wear-resistance element 22/122 can be partially or fully formed in-situ on the substrate 24, separately fully or partially pre-fabricated and then joined to the substrate 24 or fabricated and provided without a substrate.

In a further example, the forming of the wear-resistance element 22/122 can include powder processing, where a boron-containing metallic powder and a powder of the non-precipitated hard phase 28/128 are fused together to form the wear-resistance element 22/122. In a further example, the boron-containing metallic powder and the powder of the non-precipitated hard phase 28/128 have an equivalent average size within ±10%. In one example, the regions of the non-precipitated hard phase 28/128 have an average size of 45 micrometers or less. Especially if slurry processing is used, the relative equivalence in size of the powders facilitates suspending the powder in the slurry. If the powder of the non-precipitated hard phase is too large in size, the particles will settle rather than uniformly distribute through the slurry, resulting in a non-uniform dispersion in the wear-resistance element 22/122.

The powders can be included in a slurry with a carrier fluid, which can then be cast to form a green body. The carrier fluid can then be removed and the remaining green body can then be fused together under elevated temperatures to form the wear-resistance element 22/122. The selected fusing temperature will depend upon the composition of the boron-containing metallic powder, for example. Given this description, one of ordinary skill in the art will be able to select a suitable temperature for their selected composition. Alternatively, the powders can be deposited onto a substrate using a deposition process, such as plasma spraying, arc spraying, indirect heating or laser cladding. In other alternatives, the wear-resistance element 22 can be joined to the substrate 24 by a continuous weld, a discontinuous stich weld, an adhesive, diffusion bonding, a fastener or the like, for example. One or more of the wear-resistance element 22 can be attached to an end use component.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is for explanation rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A hard-faced article comprising:
a wear-resistance element including a precipitated hard phase and a non-precipitated hard phase different from the precipitated hard phase in composition, the precipitated hard phase and the non-precipitated hard phase being dispersed through a boron-containing metallic matrix, the precipitated hard phase including a boride material.

2. The article as recited in claim 1, wherein the boron-containing metallic matrix is iron-based.

3. The article as recited in claim 1, wherein the boron-containing metallic matrix is cobalt-based.

4. The article as recited in claim 1, wherein the boron-containing metallic matrix is nickel-based.

5. The article as recited in claim 1, wherein the wear-resistance element includes, by weight, 3% or greater of boron.

6. The article as recited in claim 1, wherein the wear-resistance element includes boron, carbon, chromium and silicon such that, by weight exclusive of the non-precipitated hard phase, a product of the amounts of boron, carbon, chromium and silicon is greater than 28 and less than 350 and the amount of chromium, by weight, is a non-zero amount less than 15%.

7. The article as recited in claim 6, wherein the boron-containing metallic matrix is iron-based.

8. The article as recited in claim 7, wherein the amount of chromium is greater than 5%.

9. The article as recited in claim 1, wherein the precipitated hard phase has an average size S1 and the non-precipitated hard phase has an average size S2 that is larger than the average size S1.

10. The article as recited in claim 1, wherein the non-precipitated hard phase is spheroidal.

11. The article as recited in claim 1, wherein the non-precipitated hard phase is non-spherical.

12. The article as recited in claim 11, wherein the non-precipitated hard phase has an aspect ratio of 1-5.

13. The article as recited in claim 1, wherein the non-precipitated hard phase is selected from the group consisting of carbides.

14. The article as recited in claim 1, wherein the non-precipitated hard phase is selected from the group consisting of nitrides.

15. The article as recited in claim 1, wherein the non-precipitated hard phase includes tungsten carbide.

16. The article as recited in claim 1, wherein the non-precipitated hard phase includes boron nitride.

17. The article as recited in claim 1, wherein the non-precipitated hard phase includes silicon carbide.

18. The article as recited in claim 1, wherein the wear-resistance element includes, by weight, up to 50% of the non-precipitated hard phase.

19. The article as recited in claim 1, wherein the wear-resistance element includes, by weight, 10-20% of the non-precipitated hard phase.

20. A hard-faced article comprising:
a wear-resistance element including a precipitated hard phase and, by weight, less than 50% of a non-precipitated hard phase different from the precipitated hard phase in composition, the precipitated hard phase and the non-precipitated hard phase being dispersed through a boron-containing metallic matrix, the precipitated hard phase including a boron-containing material, the wear-resistance element including boron, carbon, chromium and silicon such that, by weight exclusive of the non-precipitated hard phase, a product of the amounts of boron, carbon, chromium and silicon is greater than 28 and less than 350 and the amount of chromium by weight is less than 15%.

21. A method of processing a hard-faced article, the method comprising:
forming a wear-resistance element with a precipitated hard phase and a non-precipitated hard phase dispersed through a boron-containing metallic matrix, the precipitated hard phase differing from the non-precipitated hard phase in composition, and the precipitated hard phase including a boride material.

22. The method as recited in claim 21, wherein the forming includes forming the wear-resistance element from a boron-containing metallic powder and a powder of the non-precipitated hard phase.

23. The method as recited in claim 22, wherein the boron-containing metallic powder and the powder of the non-precipitated hard phase have equivalent average particle size ±10%.

24. The method as recited in claim 21, wherein the forming includes depositing a powdered material onto a substrate and fusing the powdered material to form the wear-resistance element.
